(19) United States
(12) Patent Application Publication
(10) Pub. No.: US 2023/0081250 A1
(43) Pub. Date: Mar. 16, 2023

(54) ROBOTIC PRODUCT PACKING

(71) Applicant: INTERNATIONAL BUSINESS MACHINES CORPORATION, Armonk, NY (US)

(72) Inventors: Venkata Vara Prasad Karri, Visakhapatnam (IN); Shailendra Moyal, Pune (IN); Sarbajit K. Rakshit, Kolkata (IN)

(21) Appl. No.: 17/474,804

(22) Filed: Sep. 14, 2021

(51) Int. Cl. G06Q 30/06; G06Q 10/08; G05B 19/4155

(52) U.S. Cl. CPC G06Q 30/0601; G06Q 10/087; G05B 19/4155; G05B 2219/40269

(57) ABSTRACT

Packing store items in a shopping cart using a robotic device can include determining packing preferences of a user. A product and at least one attribute of the product can be identified in response to the user placing the product in the shopping cart. In response to the user placing the product among other products in the shopping cart, the product and other products in the shopping cart can be arranged based on the packing preference and at least one attribute of each product. Packing of products can be initiated in response to detecting completion of shopping by the user.

### TECHNICAL FIELD

This disclosure relates to robotics and, more particularly, to robotic packing of store items in real-time during a shopping event.

### BACKGROUND

During a shopping event in a bricks-and-mortar establishment, a shopper typically browses products physically placed on shelves or displays. The shopper can select among various items displayed. In an establishment such as a grocery store in which the shopper may select a number of products, the shopper often uses a wheeled shopping cart that the shopper maneuvers through separate aisles of products. Selecting products to purchase, the user places the products in the shopping cart and moves to a checkout counter. At the checkout counter, the products' prices are scanned and the products packaged for carry out or set aside for later delivery to the shopper's address.

### SUMMARY

In an example implementation, a method of packing store items in a shopping cart using a robotic device may include determining a packing preference of a user in response to user input. The method may include identifying in real-time a product and at least one attribute of the product in response to the user placing the product in the shopping cart. The method may include recognizing in real-time a placement of the product in the shopping cart using an optical subsystem communicatively coupled with the robotic device. In response to the user placing the product among other products in the shopping cart, the method may include using the robotic device to arrange the product and other products in the shopping cart based on the packing preference and at least one attribute of each product. The method may include initiating packing by the robotic device of the product in response to detecting completion of shopping by the user.

In another example implementation, a system of packing store items in a shopping cart includes a robotic device and a processor operatively coupled with the robotic device, the processor is configured to initiate operations. The operations may include determining a packing preference of a user in response to user input. The operations may include identifying in real-time a product and at least one attribute of the product in response to the user placing the product in the shopping cart. The operations may include recognizing in real-time a placement of the product in the shopping cart using an optical subsystem communicatively coupled with the robotic device. In response to the user placing the product among other products in the shopping cart, the operations may include using the robotic device to arrange the product and other products in the shopping cart by the robotic device based on the packing preference and at least one attribute of each product. The operations may include initiating packing of the product by the robotic device in response to detecting completion of shopping by the user.

In another example implementation, a computer program product includes one or more computer readable storage media, and program instructions collectively stored on the one or more computer readable storage media. The program instructions are executable by computer hardware of a robotic device control system to initiate operations. The operations may include determining a packing preference of a user in response to user input. The operations may include identifying in real-time a product and at least one attribute of the product in response to the user placing the product in the shopping cart. The operations may include recognizing in real-time a placement of the product in the shopping cart using an optical subsystem communicatively coupled with robotic device. In response to the user placing the product among other products in the shopping cart, the operations may include arranging the product and other products in the shopping cart by the robotic device based on the packing preference and at least one attribute of each product. The operations may include initiating packing of the product by the robotic device in response to detecting completion of shopping by the user.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 illustrates an example in-cart packaging and pricing control system.

FIG. 2 illustrates an example in-cart packaging and pricing control methodology implemented using the system of FIG. 1.

FIGS. 3A and 3B illustrate an example robotic device mounted to a cart and controlled by the system of FIG. 1.

FIG. 4 illustrates an example robotic device mounted to a cart and controlled by the system of FIG. 1.

FIG. 5 illustrates an example device for implementing an in-cart packaging and pricing control system.

FIG. 6 depicts a cloud computing environment.

FIG. 7 depicts abstraction model layers.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to robotics and, more particularly, to robotic packing of store items in real-time during a shopping event. The placing of products on a counter, scanning the products' prices, and packaging the products for carry or conveyance—as during a typical shopping event—occur sequentially. The step-by-step process consumes the shopper's time and usually that of perhaps one or more store clerks who scan and package the products manually. The time delay can be annoying to the shopper. The process can be costly to the retailer or wholesaler, as the customer throughput is slowed, and labor costs incurred as one or more clerks tally prices and package the products.

In accordance with the inventive arrangements described within this disclosure, example methods, systems, and computer program products are provided that are capable of using robotics to package and price products in the shopping cart before the shopper reaches a checkout point. Moreover, the robotic packaging can sort and segment the products so that the products are more efficiently and conveniently arranged for the shopper. Packaging can be robotically performed according to the shopper's preferences expressed through electronic input by the shopper. Thus, not only are time savings achieved by in-cart packaging and pricing, but moreover, the products can be packaged in an arrangement that accommodates the shopper's preferences. The shopper can conveniently specify which products the shopper wishes to carry, and which should be shipped by the seller. Additionally, with some implementations disclosed herein, in-cart packaging can automatically arrange the products to conveniently fit in the trunk space of the user's vehicle.

In one or more example implementations, the in-cart packaging and pricing of products prior to checkout can be performed using a robotic device mounted to a conventional cart (e.g., wheeled shopping basket) or unconventional cart (e.g., motorized cart or train of detachably connected carts). In certain implementations the robotic device includes camera sensors, scanners, and/or other imaging capabilities for detecting product selection and performing product sorting. The robotic device can include a robotic arm for moving products placed in the cart, arranging placement of the products within the cart according to one or more product attributes and shopper preferences. In certain arrangements, the robotic device includes or is operatively coupled with a control unit for directing the robotic device's operations.

In other example implementations, the robotic device can be wirelessly controlled by a remotely located control unit. The remotely located control unit can comprise hardwired circuitry for executing predefined control operations. In yet other example implementations, the control unit can comprise a computer node (e.g., a store-based or cloud-based server) having one or more processors for executing program code for directing the operations of the robotic device.

Further aspects of the inventive arrangements are described below in greater detail with reference to the figures. For purposes of simplicity and clarity of illustration, elements shown in the figures are not necessarily drawn to scale. For example, the dimensions of some of the elements may be exaggerated relative to other elements for clarity. Further, where considered appropriate, reference numbers are repeated among the figures to indicate corresponding, analogous, or like features.

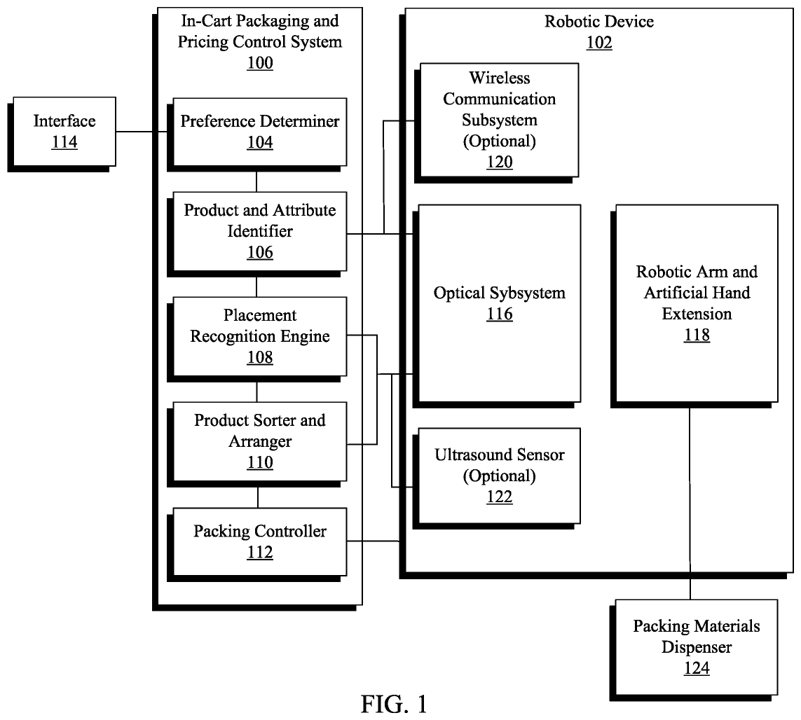

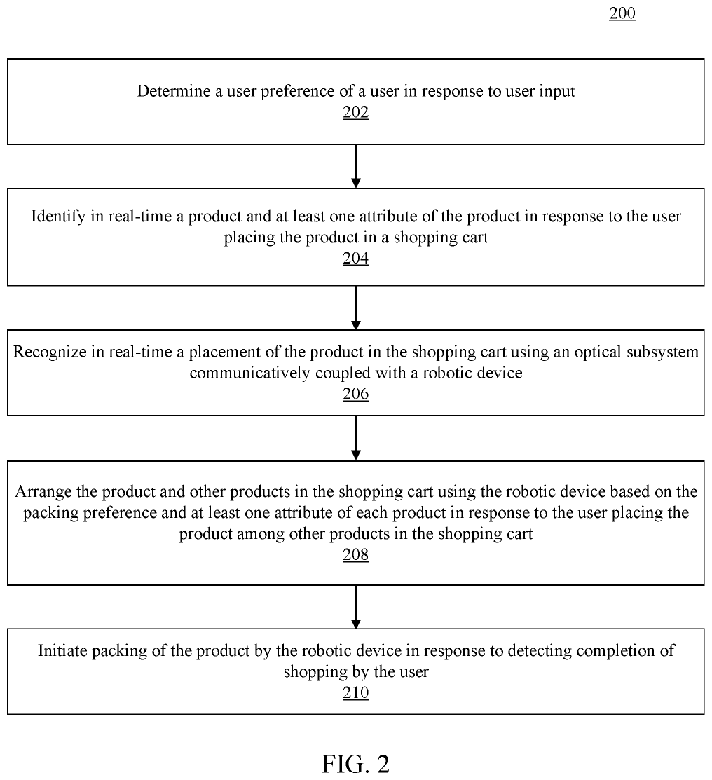

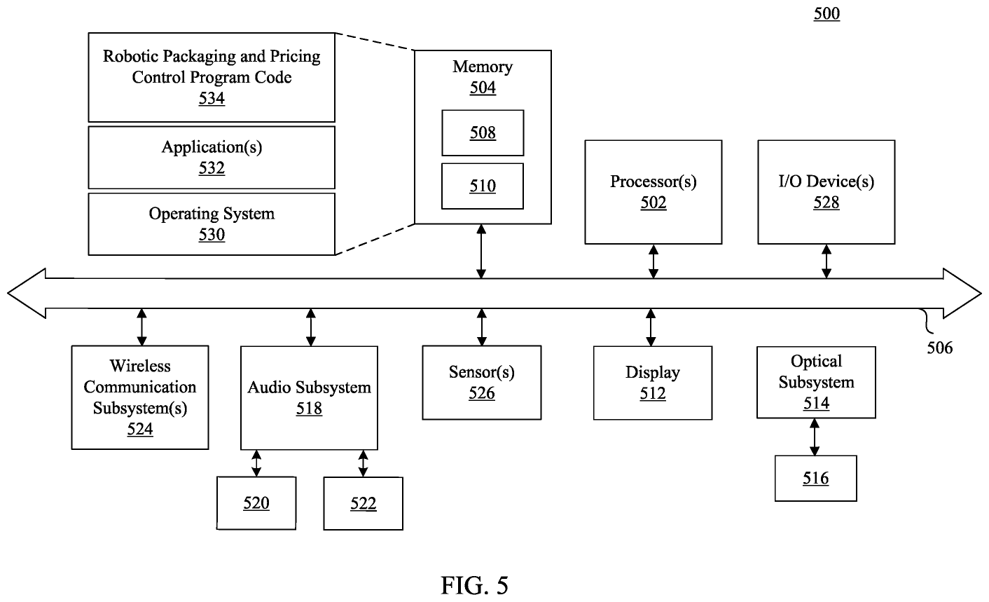

FIGS. 1 and 2 illustrate, respectively, example in-cart packaging and pricing control system (system 100) and methodology 200 implemented with the system. System 100 can be implemented in hardware (e.g., dedicated circuitry), software (e.g., program code executed by one or more processors), or a combination of hardware and software. For example, system 100 can be implemented in a device comprising a combination of hardware and software such as device 500 (FIG. 5). System 100, in different embodiments, operatively couples via a wireless or wired connection to robotic device 102, which under the control of system 100 performs physical actions for packaging and pricing products placed in a shopping cart (not shown).

In certain arrangements, system 100 is embedded in and integrated with the circuitry of robotic device 102. In other arrangements, system 100 is implemented in a separate device but mounted on the same cart as robotic device 102. In still other arrangements, system 100 is implemented in a separate device (e.g., store-based device or cloud-based server), which is remote from the cart to which robotic device 102 is mounted and is operatively coupled with robotic device 102 via a wireless connection (e.g., store-wide Wi-Fi or cellular network). Illustratively, system 100 includes preference determiner 104, product and attribute identifier 106, placement recognition engine 108, product sorter and arranger 110, and packing controller 112, each of which is implemented in hardware, software, or a combination thereof.

Preference determiner 104 receives user input through interface 114, which communicatively couples with preference determiner 104 via a wired or wireless connection. Interface 114 can be an I/O device such as I/O device 528 (FIG. 5) for receiving user input specifying a user's preference for the mode and arrangements in which selected products are packed for carry out once the user has finished shopping. The user input can be character-based, in which case interface 114 is implemented as an I/O device comprising a keyboard, a display and pointing device, or similar such interface (e.g., a touch-enabled display). In other arrangements, user input can be voice-based, with interface 114 implemented for example as an audio subsystem 518 coupled to a microphone 522 to facilitate voice-enabled functions, such as voice recognition (FIG. 5). In other arrangements, interface 114 can receive visual input (e.g., photograph) such as an image of the user's vehicle or the inside of the vehicle's trunk, the image serving to indicate space availability for transporting purchased products. Interface 114, in certain arrangements, is a wireless interface that enables the user to input preferences using a remote device (e.g., smartphone).

At block 202, preference determiner 104 is capable of determining one or more user preferences for product packing. A preference can specify, for example, how a user prefers products to be packed in bags, boxes, or the like for carrying products from the store once the user has finished shopping. For example, a user who wishes to maintain food products separate from chemical products (e.g., anti-insect spray, household bleach or detergent, paint products) can specify a preference that these or other types of products be packed separately. A preference can specify, for example, that specific products or product types (e.g., eggs, meats, or milk) be packed for transporting from the store in the interior of a vehicle while other types are transported in the trunk of the vehicle, The user preference can implicitly designate the amount of room for carrying products in the trunk or interior of the vehicle by listing or voicing the type of vehicle the user is driving or by transmitting a photograph (e.g., using a smartphone camera) of the trunk space of the vehicle. The user preference, as noted above, is in certain arrangements is conveyed wirelessly to interface 114.

At block 204, product and attribute identifier 106 is capable of identifying a product and one or more attributes of the product. Product and attribute identifier 106 can identify the product and one or more attributes in real-time in response to the user placing the product in the shopping cart to which robotic device 102 is mounted. In certain embodiments, product and attribute identifier 106 identifies the product and attribute(s) related thereto from an image captured by optical subsystem 116. An example optical subsystem is optical subsystem 514, which is coupled to optical sensor 516 (FIG. 5). Optical subsystem 116 communicatively couples with and can be integrated in or attached to another element, such as robotic arm and artificial hand extension 118 of robotic device 102. Optical subsystem 116, in certain embodiments, comprises an optical scanner (e.g., laser scanner) that scans images comprising machine-readable data (e.g., label or barcode printed on a package). Product and attribute identifier 106 can identify a product from the scanned-in data by comparing the input with data electronically stored by product and attribute identifier 106 or retrieved from a database communicatively coupled via a wireless connection with product and attribute identifier 106.

Optical subsystem 116, in various embodiments, including those typified by optical subsystem 514, can provide machine vision using different types of imagining, including 2D scanning, 3D imagining, and/or other imaging. Images captured by optical subsystem 116 can be processed by product and attribute identifier 106, the process including detecting edges, identifying obstacles, performing pixel counts, and recognizing patterns. Product and attribute identifier 106 thus can identify a product and one or more attributes in real-time by processing the images captured with optical subsystem 116 to identify objects and recognize patterns.

Optionally, product and attribute identifier 106, additionally or alternatively, can communicatively couple with wireless communication system 120, which can also be integrated in or attached to robotic arm and artificial hand extension 118 of robotic device 102. An example wireless communication subsystem is wireless communication subsystem 524 (FIG. 5). Wireless communication subsystem 120, for example, can provide an RFID system comprising an RFID reader and RFID tags attached to various products. Accordingly, based on data that product and attribute identifier 106 electronically stores or retrieves wirelessly from a database, product and attribute identifier 106 can identify a product and/or one or more attributes of the product from an RFID tag attached to the product and read by an RFID reader.

Product and attribute identifier 106 thus not only can identify the product but also determine one or more product attributes such as the product type, the producer, packaging dimensions, and/or storage conditions. Based on type, for example, product and attribute identifier 106 can distinguish food items from household cleaning products. Product and attribute identifier 106 based on the one or more attributes can determine, for example, a preferred temperature for maintaining a product such as frozen vegetables or ice cream. Based on certain attributes, product and attribute identifier 106 can determine, for example, the fragility of different products, as well as the products' size (including container or packaging), weight, and/or dimensions.

At block 206, placement recognition engine 108 is capable of recognizing a placement of the product in the shopping cart. “Placement” refers to the location of the product within the cart and/or the product's position relative to one or more other products placed within the cart. Placement recognition engine 108, in certain embodiments, can recognize in real-time the placement of products in the shopping cart based on images acquired using optical subsystem 116. For example, in some embodiments, optical subsystem 116 can capture 2D images and/or 3D images using a 3D-camera. In certain embodiments, placement recognition engine 108 implements an object detection algorithm for detecting the placement of objects (products). The object detection algorithm can comprise, for example, a deep learning neural network or other machine learning model trained using supervised learning.

Based on the imaging and/or object detection, placement recognition engine 108 can determine whether the product is placed in a region of the cart according to a user-specified preference. If the user has designated a region, and the user's initial placement is not in accordance with the expressed preference, then robotic device 102, using robotic arm and artificial hand extension 118, can move the product and re-position the product in the region designated.

Optionally, placement recognition engine 108 can recognize product placements based on ultrasound imaging performed by ultrasound sensor 122. Placement recognition engine 108 can communicatively couple with ultrasound sensor 122, which can be integrated in or attached to another element (e.g., robotic arm) of robotic device 102.

At block 208, product sorter and arranger 110 is capable of arranging the product and any other products positioned in the cart according to the preferences specified by the user, the placement of each product determined by placement recognition engine 108 and/or attributes identified by product and attribute identifier 106. For example, if the user input specifies a preference for separating food items from chemical products, then product sorter and arranger 110 using optical subsystem 116 (implementing, e.g., object detection and pattern recognition) can determine the products' positions, sort the products, and separate the two types of products accordingly. Product sorter and arranger 110, additionally or alternatively, sorts and arranges multiple products in the cart according to the one or more product attributes of each product, as determined by product and attribute identifier 106. Accordingly, product sorter and arranger 110 can arrange placement of the products in the cart in accordance with user-specified preference(s) and/or product attribute(s). Product sorter and arranger 110 determines the positions in which sorted products should be placed in and, following the dictates of product sorter and arranger 110, robotic arm and artificial hand extension 118 can pick up and move the products to arrange the products according to the designated arrangement. Product sorter and arranger 110 can arrange the products in response to initially detecting that the user has placed the product among other products (typically the case after the user has placed one product in the cart).

In certain embodiments, product sorter and arranger 110 uses each product's type, specification, and/or dimensions to sort products according to their respective compatibilities with one another. For example, heavier items can be sorted so as to be layered beneath lighter weight items. With respect to food items, for example, frozen foods (e.g., meat, poultry, or fish) can be segregated from non-frozen items. In certain embodiments, in which the cart to which robotic device 102 is mounted comprises two or more layers, products can be sorted so that each is placed in a layer appropriate to each product's type, specification, and/or dimensions. For example, fragile items (e.g., eggs) can be identified and placed on a different layer than non-fragile ones.

Additionally, placement recognition engine 108 can recognize that a shopper has had a change of mind and removed an earlier selected product from the cart. Product sorter and arranger 110 is capable of responding by rearranging the placement of other products after the one product is removed from the shopping cart. Using optical subsystem 116 (implementing, e.g., object detection and pattern recognition), product sorter and arranger 110 can determine a rearrangement of the products remaining in the cart based on the user's packing preference(s) and/or attribute(s) of the products remaining. Robotic arm and artificial hand extension 118 can move the remaining products in the cart in accordance with the rearrangement determined by product sorter and arranger 110.

Packing controller 112 is capable of initiating packing of the products in the cart in response to detecting the completion of shopping by the user. In some embodiments, packing controller 112 detects the user's completion of shopping in response to a wireless (e.g., RF) signal captured with wireless communication subsystem 120, which indicates a direction that the cart is traveling and/or a position of the cart. For example, the wireless signal may indicate that the cart is traveling in the direction of a specific checkout point or is within of a predetermined checkout area. Packing controller 112 detects the completion of shopping prior to the user and the cart arriving at the final checkout point. This enables packing controller 112 to direct the robotic device 102 to complete the packing of the sorted and arranged products prior to reaching the final checkout point. Additionally, given that an attribute of each product can include the product's price, packing controller 112 can tabulate a total cost for the products as the products are packed. Thus, when the user with the cart reaches the final checkout point, the entire process of packing and pricing is already complete. The shopper is ready to pay for the products or already has paid through a wireless electronic transaction and can exit the store with the products packed for easy and convenient carry out. The shopper is thus relieved of the burden of having to unload the contents of the cart, manually pack individual items, and return items to the cart as is customary in checking out with a clerk or in performing self-checkout.

In some arrangements in which the user specifies a preference for separating items that will be transported in the interior of the user's vehicle from those that will be transported in the vehicle's trunk, product sorter and arranger 110 can allocate the individual products into separate groups accordingly. Additionally, or alternatively, product sorter and arranger 110 can sort and arrange products so that the products can be properly placed in the available space of the vehicle's trunk. Product sorter and arranger 110, as described above, can determine based on user input the available space in the user's trunk. The determination can be based on character input specifying the vehicle's make and model, user-specified dimensions, or even a current photograph taken of the open interior of the trunk before commencing shopping.

Packing controller 112 can control robotic arm and artificial hand extension 118 to wrap products in distinct groups, based on the sorting performed by product sorter and arranger 110 and using packing materials dispensed by packing materials dispenser 124.

For example, product sorter and arranger 110 can allocate individual products by sorting the products into groups that can be wrapped by robotic arm and artificial hand extension 118 under the direction of packing controller 112 so as to fit within the available trunk space of the user's vehicle. Thus, for example, if the trunk space is four feet across and three feet deep, product sorter and arranger 110 dictates creating N different groups of products that, when wrapped, fit in the that space as a grid (e.g., using a puzzle or template approach). In the event that not all the groups of wrapped products can fit on the floor of the vehicle's trunk, product sorter and arranger 110 can dictate that another layer of wrapped packages be created by robotic arm and artificial hand extension 118 under the direction of packing controller 112 so that the two layers are not higher than the internal height of the trunk. The arrangement dictated by product sorter and arranger 110 would also ensure that heavier products are able to be positioned on the bottom layer and conform with other food grouping preferences of the user.

In certain arrangements, user preferences input via interface 114 can include a shopping list, that is, an itemization of products that the user wishes to purchase during a shopping event. The list of items can be prepared by the shopper in advance and scanned in using an optical scanner of interface 114 or input via interface 114 after the shopper enters the store. The product sorter and arranger 110 can be aided by the list of items placed in the cart for purposes of recognizing positions of the items. In certain embodiments, product sorter and arranger 110 can be configured to perform predictive sorting and arranging. Product sorter and arranger 110 performs predictive sorting and arranging by receiving the shopping list and predicting which product(s) will be placed in the cart as the user successively adds products to the cart. Product sorter and arranger 110 can use the information from the shopping list to simulate the arranging of products yet to be added to the cart. Additionally, in some arrangements, product sorter and arranger 110's prediction is aided by wirelessly tracking the movement of the cart among different aisles of the store using a tracking device (not shown) communicatively coupled with sorter and arranger 110 to determine which products may be added next based on the cart's proximity to the shelf that the product expected to be added occupies.

For example, the shopper may have just placed produce in the cart. Product sorter and arranger 110, based on the shopping list, predicts that the shopper will also place in the cart a jar of cooking oil, a container of ice cream, and a packet of rice. In some embodiments, the order of adding the products also may be predicted based on the immediate position of the cart, for example. Based on the prediction, product sorter and arranger 110 can convey information to product packer 112 to direct robotic arm and artificial hand extension 118 to position the produce to accommodate the expected addition of the cooking oil, ice cream, and rice. Moreover, to avoid damaging products owing to product stacking, product sorter and arranger 110 can allocate products in anticipation of an addition of products having different weights, varied temperatures, or attributes that could adversely affect other products on the user's shopping list. For example, because the heavier weighted jar of cooking oil or frozen temperature of the ice cream could adversely affect the produce, product sorter and arranger 110 can instruct product packer 112 to direct placement of the produce so that the produce subsequently can be moved on top of the heavier jar of oil as needed to make room in the cart and so as to avoid contact with the frozen ice cream.

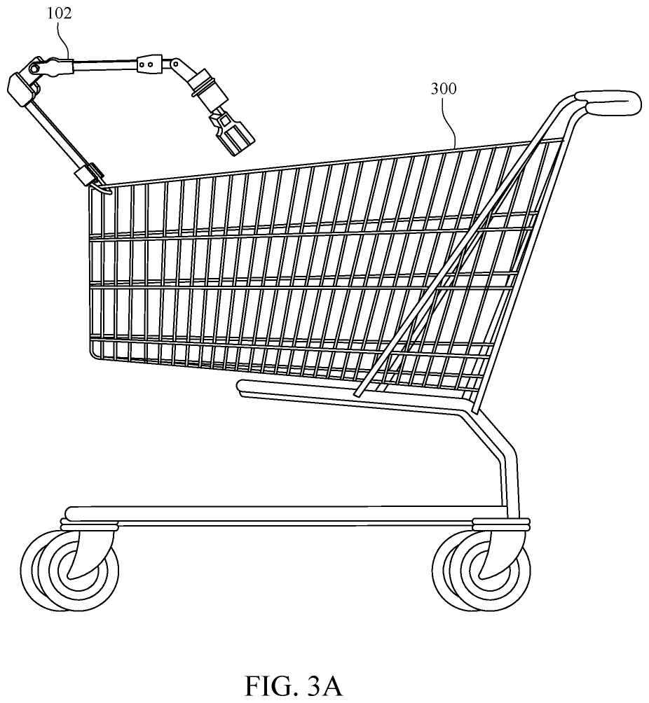

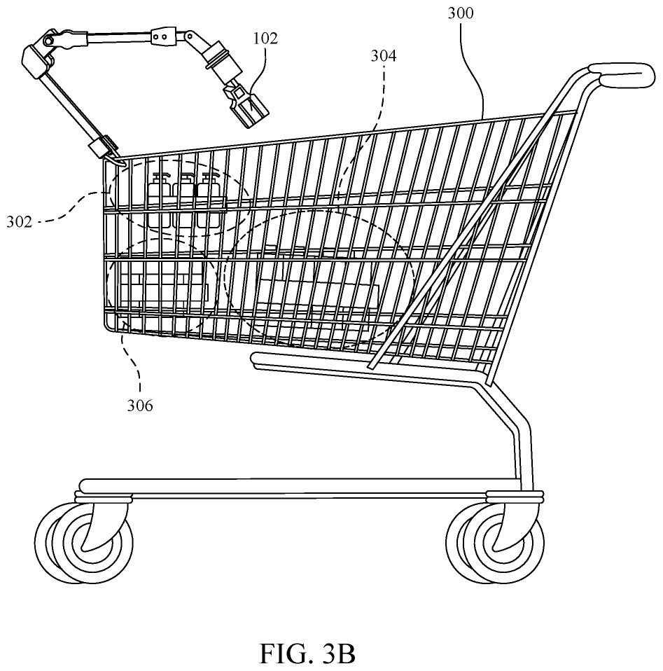

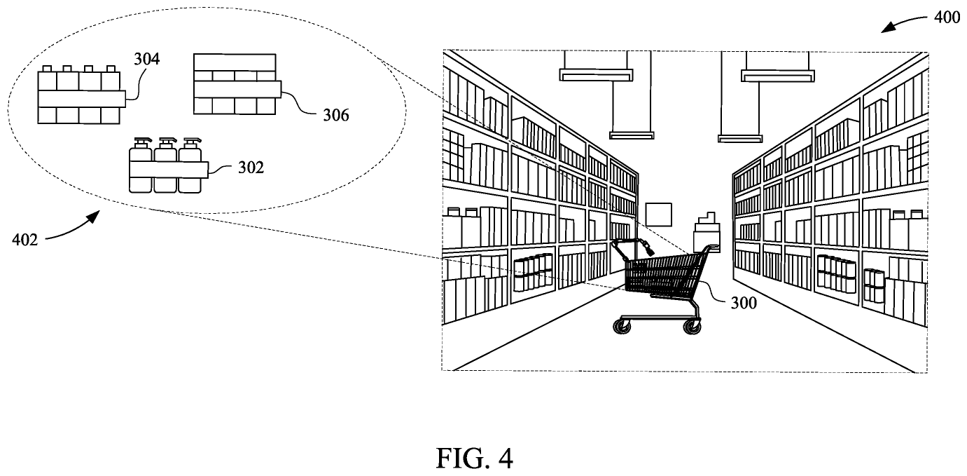

FIGS. 3A and 3B illustrate example cart 300 to which robotic device 102, controlled by system 100, is mounted. As illustrated in FIG. 3A, cart 300 is a typical wheeled shopping basket and robotic device 102 is mounted at the front end. Although, as illustrated, cart 300 is a conventional shopping basket, in other embodiments various other types of carts can be used and the robotic device mounted thereon can be configured to accommodate each cart's specific features. According to the procedures performed using robotic device 102 under the control of system 100, products are sorted into distinct product groups 302, 304, 306 and arranged in separate layers, as illustrated in FIG. 3B. As further illustrated in FIG. 4, when cart 300 is traveling toward or within checkout area 400, the grouped products 302, 304, and 306 are wrapped into distinct groups 402 and their prices tallied electronically by system 100.

By the time the user and cart arrive at a final checkout point, all of the products are segmented properly and positioned within carry bags and/or boxes for easy conveyance from the store by the user or a clerk.

FIG. 5 illustrates example device 500 in which an in-cart product packing and pricing system such as system 100 can be implemented. Device 500 includes one or more processors 502 coupled to memory 504 through interface circuitry 506. Device 500 stores computer readable instructions (also referred to as “program code”) within memory 504, which is an example of computer readable storage media. Processor(s) 506 execute the program code accessed from memory 504 via interface circuitry 506.

Memory 504 can include one or more physical memory devices such as local memory 508 and bulk storage device 510, for example. Local memory 508 is implemented as one or more non-persistent memory device(s) generally used during actual execution of the program code. Local memory 508 is an example of a runtime memory. Examples of local memory 508 include any of the various types of RAM suitable for use by a processor for executing program code. Bulk storage device 510 is implemented as a persistent data storage device. Examples of bulk storage device 510 include a hard disk drive (HDD), a solid-state drive (SSD), flash memory, a read-only memory (ROM), an erasable programmable read-only memory (EPROM), electrically erasable programmable read-only memory (EEPROM), or other suitable memory. Device 500 can also include one or more cache memories (not shown) that provide temporary storage of at least some program code in order to reduce the number of times program code must be retrieved from a bulk storage device during execution.

Examples of interface circuitry 506 include, but are not limited to, an input/output (I/O) subsystem, an I/O interface, a bus system, and a memory interface. For example, interface circuitry 506 can be implemented as any of a variety of bus structures and/or combinations of bus structures including a memory bus or memory controller, a peripheral bus, an accelerated graphics port, and a processor or local bus.

In one or more example implementations, processor(s) 502, memory 504, and/or interface circuitry 506 are implemented as separate components. Processor(s) 502, memory 504, and/or interface circuitry 506 may be integrated in one or more integrated circuits. The various components in device 500, for example, can be coupled by one or more communication buses or signal lines (e.g., interconnects and/or wires). Memory 504 may be coupled to interface circuitry 506 via a memory interface, such as a memory controller or other memory interface (not shown).

Device 500 can include one or more displays. Illustratively, for example, device 500 includes display 512 (e.g., a screen). Display 512 can be implemented as a touchscreen display capable of receiving touch input from a user. A touchscreen is a touch-sensitive display and/or a touch-sensitive pad that is capable of detecting contact, movement, gestures, and breaks in contact using any of a variety of available touch sensitivity technologies. Example touch-sensitive technologies include, but are not limited to, capacitive, resistive, infrared, and surface acoustic wave technologies, and other proximity sensor arrays or other elements for determining one or more points of contact with a touch-sensitive display and/or device.

Device 500 can include optical subsystem 514. Optical subsystem 514 can be coupled to interface circuitry 506 directly or through a suitable input/output (I/O) controller. Optical subsystem 514 can be coupled to optical sensor 516. Optical sensor 516 can be implemented using any of a variety of technologies. Examples of optical sensor 516 can include, but are not limited to, a 3D or other type of camera, a laser, a charged coupled device (CCD) or a complementary metal-oxide semiconductor (CMOS) optical sensor. Optical subsystem 514 and optical sensor 516 are capable of performing camera functions such as recording or capturing images and/or recording video. Optical subsystem 514 and optical sensor 516 can be configured as a bar code reader (e.g., laser scanner) to read bar codes placed on product packages or labels.

Optical subsystem 514 can be configured to implement robotic vision. Using different configurations of optical sensor 516, optical subsystem 514 can scan 2D objects for line and barcode scanning. Optical subsystem 514, in which optical sensor 516 is a 3D camera or similar type optical device, can perform 3D imaging. Optical subsystem 514, in implementing robotic vision, can additionally include one or more processors for performing image processing. Performing image processing, optical subsystem 514 can detect edges, identify obstructions, perform pixel counts, discover and manipulate visual objects based on programming of the processors. Optical subsystem 514, more generally, can be hardwired or can be programmed to recognize objects and patterns.

Device 500 can include an audio subsystem 518. Audio subsystem 518 can be coupled to interface circuitry 506 directly or through a suitable input/output (I/O) controller. Audio subsystem 518 can be coupled to a speaker 520 and a microphone 522 to facilitate voice-enabled functions, such as voice recognition and/or telephony functions to receive, for example, user input.

Device 500 can include one or more wireless communication subsystems 524. Each of wireless communication subsystem(s) 524 can be coupled to interface circuitry 506 directly or through a suitable I/O controller (not shown). Each of wireless communication subsystem(s) 524 is capable of facilitating communication functions. Examples of wireless communication subsystems 524 can include, but are not limited to, radio frequency receivers and transmitters, and optical (e.g., infrared) receivers and transmitters. The specific design and implementation of wireless communication subsystem 524 can depend on the particular type of device 500 implemented and/or the communication network(s) over which device 500 is intended to operate.

As an illustrative and non-limiting example, wireless communication subsystem(s) 524 may be designed to operate over one or more mobile networks, WiFi networks, short range wireless networks (e.g., a Bluetooth), and/or any combination of the foregoing. Wireless communication subsystem(s) 524 can implement hosting protocols such that device 500 can be configured as a base station for other wireless devices. Wireless communication subsystem 524 can comprise an RFID system that can identify products and extract product attributes from tags attached to objects (e.g., products and product packaging) using electromagnetic fields.

Device 500 may include one or more sensors 526, each of which can be coupled to interface circuitry 506 directly or through a suitable I/O controller (not shown). Sensor(s) 526 can include, but are not limited to, an ultrasound sensor, a motion sensor, a light sensor, and a proximity sensor to facilitate orientation, lighting, and proximity functions, respectively, of device 500. As an ultrasound sensor, sensor 526 can recognize the placement of products in a cart, for example.

Device 500 further may include one or more input/output (I/O) devices 528 coupled to interface circuitry 506. I/O device(s) 528 can be coupled to interface circuitry 506 either directly or through intervening I/O controllers (not shown). Examples of I/O devices 528 include, but are not limited to, a track pad, a keyboard, a display device, a pointing device, one or more communication ports (e.g., Universal Serial Bus (USB) ports), a network adapter, and buttons or other physical controls. A network adapter refers to circuitry that enables device 500 to become coupled to other systems, computer systems, remote printers, and/or remote storage devices through intervening private or public networks. Modems, cable modems, Ethernet interfaces, and wireless transceivers not part of wireless communication subsystem(s) 524 are examples of different types of network adapters that may be used with device 500. One or more of I/O devices 528 may be adapted to control functions of one or more or all of sensors 526 and/or one or more of wireless communication subsystem(s) 524.

Memory 504 stores program code. Examples of program code include, but are not limited to, routines, programs, objects, components, logic, and other data structures. For purposes of illustration, memory 504 stores an operating system 530 and application(s) 532. In addition, memory 504 can store in-cart product packing and pricing control program code 534, as described within this disclosure.

In an aspect, operating system 530 implemented in executable program code is executed by device 500 and, more particularly, by processor(s) 502, as are applications 532 and in-cart product packing and pricing program code 534. As such, operating system 530, application(s) 532 and in-cart product packing and pricing program code 534 may be considered an integrated part of device 500. Further, it should be appreciated that any data and/or program code used, generated, and/or operated upon by device 500 (e.g., processor(s) 502) are functional data structures that impart functionality when employed as part of device 500.

Device 500 is provided for purposes of illustration and not limitation. A device and/or system configured to perform the operations described herein can have a different architecture than illustrated in FIG. 5. The architecture can be a simplified version of the architecture described in connection with FIG. 5 that includes a memory capable of storing instructions and a processor capable of executing instructions. In this regard, device 500 may include fewer components than shown or additional components not illustrated in FIG. 5 depending upon the particular type of device that is implemented. In addition, the particular operating system and/or application(s) included can vary according to device type as can the types of I/O devices included. Further, one or more of the illustrative components can be incorporated into, or otherwise form a portion of, another component. For example, a processor may include at least some memory.

Device 500 can be implemented as a data processing system, a communication device, or other suitable system that is suitable for storing and/or executing program code. Example implementations of device 500 can include, but are not to limited to, a mobile device, a computer (e.g., in-store computer or cloud-based server) or comparable device.

It is expressly noted that although this disclosure includes reference to cloud computing, implementations of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

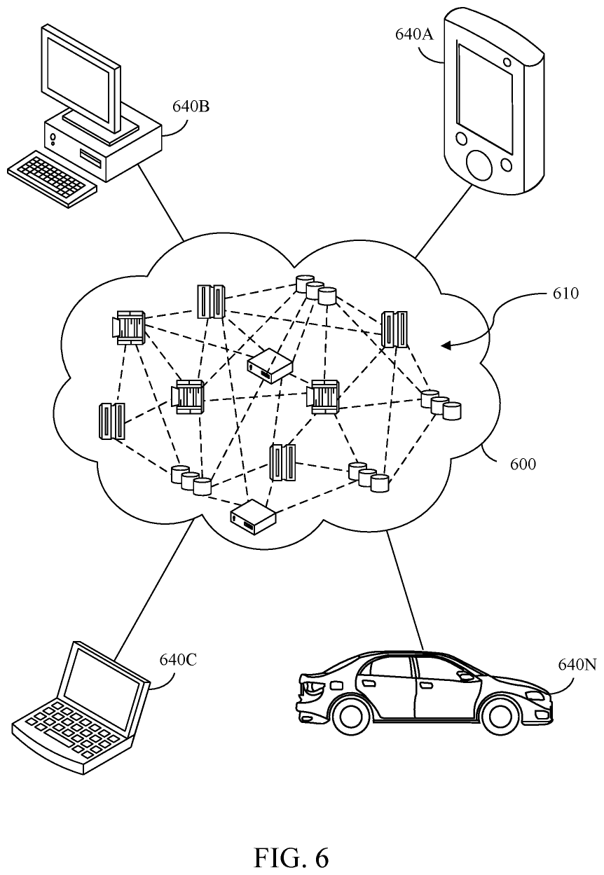

Referring now to FIG. 6, illustrative cloud computing environment 600 is depicted. As shown, cloud computing environment 600 includes one or more cloud computing nodes 610 with which local computing devices used by cloud consumers, such as, for example, personal digital assistant (PDA) or cellular telephone 640a, desktop computer 640b, laptop computer 640c, and/or automobile computer system 640n may communicate. Computing nodes 610 may communicate with one another. They may be grouped (not shown) physically or virtually, in one or more networks, such as Private, Community, Public, or Hybrid clouds as described hereinabove, or a combination thereof. This allows cloud computing environment 600 to offer infrastructure, platforms and/or software as services for which a cloud consumer does not need to maintain resources on a local computing device. It is understood that the types of computing devices 640a-n shown in FIG. 6 are intended to be illustrative only and that computing nodes 610 and cloud computing environment 600 can communicate with any type of computerized device over any type of network and/or network addressable connection (e.g., using a web browser).

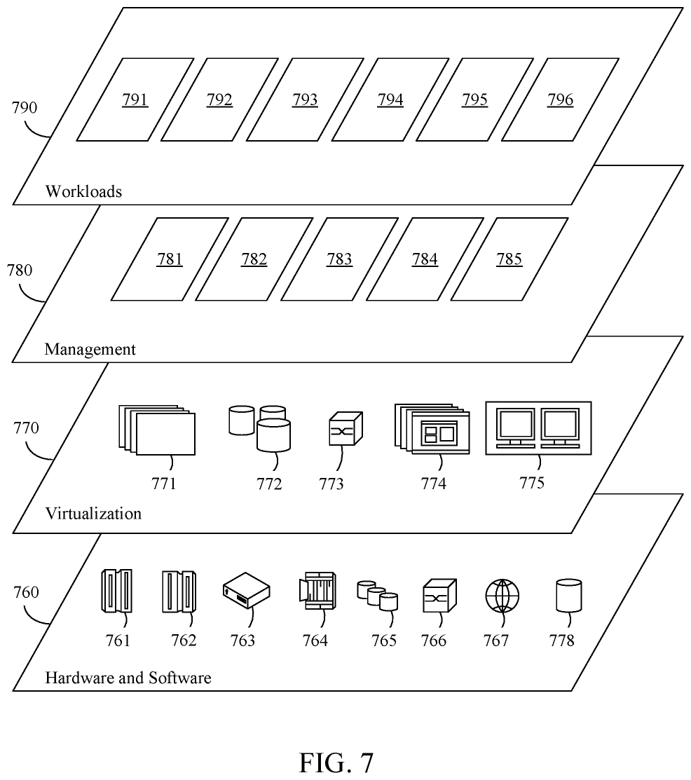

Referring now to FIG. 7, a set of functional abstraction layers provided by cloud computing environment 600 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 760 includes hardware and software components. Examples of hardware components include mainframes 761; RISC (Reduced Instruction Set Computer) architecture-based servers 762; servers 763; blade servers 764; storage devices 765; and networks and networking components 766. In some embodiments, software components include network application server software 767 and database software 768.

Virtualization layer 770 provides an abstraction layer from which the following examples of virtual entities may be provided: virtual servers 771; virtual storage 772; virtual networks 773, including virtual private networks; virtual applications and operating systems 774; and virtual clients 775.

In one example, management layer 780 may provide the functions described below. Resource provisioning 781 provides dynamic procurement of computing resources and other resources that are utilized to perform tasks within the cloud computing environment. Metering and Pricing 782 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 783 provides access to the cloud computing environment for consumers and system administrators. Service level management 784 provides cloud computing resource allocation and management such that required service levels are met. Service Level Agreement (SLA) planning and fulfillment 785 provide pre-arrangement for, and procurement of, cloud computing resources for which a future requirement is anticipated in accordance with an SLA.

Workloads layer 790 provides examples of functionality for which the cloud computing environment may be utilized. Examples of workloads and functions which may be provided from this layer include: mapping and navigation 791; software development and lifecycle management 792; virtual classroom education delivery 793; data analytics processing 794; transaction processing 795; and in-cart product packing and pricing system 796.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without human intervention.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. The different types of memory, as described herein, are examples of a computer readable storage media. A non-exhaustive list of more specific examples of a computer readable storage medium may include: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, or the like.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the term “processor” means at least one hardware circuit. The hardware circuit may be configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real-time” means a level of processing responsiveness that a user or system senses as sufficiently immediate for a particular process or determination to be made, or that enables the processor to keep up with some external process.

As defined herein, the term “responsive to” and similar language as described above, e.g., “if,” “when,” or “upon,” mean responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms “user” and “shopper” refer to a human being.

The terms first, second, etc. may be used herein to describe various elements. These elements should not be limited by these terms, as these terms are only used to distinguish one element from another unless stated otherwise or the context clearly indicates otherwise.

A computer program product may include a computer readable storage medium (or media) having computer readable program instructions thereon for causing a processor to carry out aspects of the present invention. Within this disclosure, the term “program code” is used interchangeably with the term “computer readable program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer readable program instructions may specify state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In this way, operatively coupling the processor to program code instructions transforms the machine of the processor into a special-purpose machine for carrying out the instructions of the program code. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowcharts or block diagrams may represent a module, segment, or portion of instructions, which comprises one or more executable instructions for implementing the specified operations. In some alternative implementations, the operations noted in the blocks may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts or carry out combinations of special purpose hardware and computer instructions.

The corresponding structures, materials, acts, and equivalents of all means or step plus function elements that may be found in the claims below are intended to include any structure, material, or act for performing the function in combination with other claimed elements as specifically claimed.

The description of the embodiments provided herein is for purposes of illustration and is not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the embodiments disclosed herein. Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

What is claimed is:

1. A method of packing store items in a shopping cart using a robotic device, the method comprising:
determining a packing preference of a user in response to user input;
identifying in real-time a product and at least one attribute of the product in response to the user placing the product in the shopping cart;
recognizing in real-time a placement of the product in the shopping cart using an optical subsystem communicatively coupled with the robotic device;
in response to the user placing the product among other products in the shopping cart, using the robotic device to arrange the product and other products in the shopping cart based on the packing preference and the at least one attribute of each product; and
initiating packing of the product by the robotic device in response to detecting completion of shopping by the user.

2. The method of claim 1, wherein
the packing preference corresponds to at least one of a user specification or trunk space of a user vehicle.

3. The method of claim 1, wherein
the at least one attribute of each product includes a product type, a preferred product temperature, a product packaging, a product size, a product weight, or product dimension.

4. The method of claim 1, comprising:
rearranging a placement of other products in response to detecting removal of the product from the shopping cart while other products remain in the shopping cart, the rearranging based on the packing preference and the at least one attribute of each product remaining in the shopping cart.

5. The method of claim 1, comprising:
determining a placement of each product in the shopping cart by performing an ultrasound imaging using the robotic device.

6. The method of claim 1, wherein
the detecting completion of shopping includes determining at least one of a direction of travel of the shopping cart or a presence of the shopping cart in a predetermined checkout area.

7. The method of claim 6, wherein
the detecting is performed in advance of the shopping cart reaching a predetermined checkpoint within the checkout area to enable completion of packaging before the shopping cart reaches the predetermined checkout point.

8. The method of claim 6, including:
determining and outputting a total of the prices of each product in the shopping cart in response to the detecting completion of shopping.

9. The method of claim 1, wherein the arranging includes:
sorting the product and each other product based on the at least one attribute of each product; and
based on the sorting, segmenting products into one or more predetermined product spaces within the shopping cart.

10. A system, comprising:
a robotic device; and
a processor operatively coupled with the robotic device, wherein the processor is configured to initiate operations including:
determining a packing preference of a user in response to user input;
identifying in real-time a product and at least one attribute of the product in response to the user placing the product in a shopping cart;
recognizing in real-time a placement of the product in the shopping cart using an optical subsystem communicatively coupled with the robotic device;
in response to the user placing the product among other products in the shopping cart, using the robotic device to arrange the product and other products in the shopping cart based on the packing preference and the at least one attribute of each product; and
initiating packing of the product by the robotic device in response to detecting completion of shopping by the user.

11. The system of claim 10, wherein
the packing preference corresponds to at least one of a user specification or trunk space of a user vehicle.

12. The system of claim 10, wherein
the at least one attribute of each product includes a product type, a preferred product temperature, a product packaging, a product size, a product weight, or product dimension.

13. The system of claim 10, wherein the processor is configured to initiate operations including:
rearranging a placement of other products in response to detecting removal of the product from the shopping cart while other products remain in the shopping cart, the rearranging based on the packing preference and at least one attribute of each product remaining in the shopping cart.

14. The system of claim 10, wherein the processor is configured to initiate operations including:
determining a placement of each product in the shopping cart by performing an ultrasound imaging using the robotic device.

15. The system of claim 10, wherein
the detecting completion of shopping includes determining at least one of a direction of travel of the shopping cart or a presence of the shopping cart in a predetermined checkout area.

16. The system of claim 15, wherein
the detecting is performed in advance of the shopping cart reaching a predetermined checkpoint within the checkout area to enable completion of packaging before the shopping cart reaches the predetermined checkpoint.

17. The system of claim 15, wherein the processor is configured to initiate operations including:
determining and outputting a total of the prices of each product in the shopping cart in response to the detecting completion of shopping.

18. The system of claim 10, wherein the arranging includes:
sorting the product and each other product based on the at least one attribute of each product; and
based on the sorting, segmenting products into one or more predetermined product spaces within the shopping cart.

19. A computer program product, comprising:
one or more computer readable storage media, and program instructions collectively stored on the one or more computer readable storage media, wherein the program instructions are executable by a processor of an in-cart packing and pricing control system operatively coupled to a robotic device to initiate operations including:
determining a packing preference of a user in response to user input;
identifying in real-time a product and at least one attribute of the product in response to the user placing the product in a shopping cart;
recognizing in real-time a placement of the product in the shopping cart using an optical subsystem communicatively coupled with the robotic device;
in response to the user placing the product among other products in the shopping cart, using the robotic device to arrange the product and other products in the shopping cart based on the packing preference and the at least one attribute of each product; and
initiating packing of the product by the robotic device in response to detecting completion of shopping by the user.

20. The computer program product of claim 19, wherein the program code is executable by the processor to initiate operations including:
rearranging a placement of other products in response to detecting removal of the product from the shopping cart while other products remain in the shopping cart, the rearranging based on the packing preference and at least one attribute of each product remaining in the shopping cart.
